(19) United States
(12) Patent Application Publication
(10) Pub. No.: US 2017/0185931 A1
(43) Pub. Date: Jun. 29, 2017

(54) SYSTEM AND METHOD FOR PREDICTING ESTIMATION OF PROJECT FACTORS IN SOFTWARE DEVELOPMENT ENVIRONMENT

(71) Applicant: Wipro Limited, Bangalore (IN)

(72) Inventor: Rajkumar Joghee Bhojan, Bangalore (IN)

(21) Appl. No.: 15/050,842

(22) Filed: Feb. 23, 2016

(30) Foreign Application Priority Data
Dec. 28, 2015 (IN) 6990CHE/2015

(51) Int. Cl. G06Q 10/06; G06F 9/44

(52) U.S. Cl. CPC G06Q 10/06313; G06F 8/20

(57) ABSTRACT

The present disclosure relates to a method for predicting estimations of project factors in software development environment. The method comprises receiving first input data including at least one type of first software development model and associated one or more first project data from a user. The method further comprises identifying one or more first software agents based on the at least one type of the first software development model. The method further comprises processing the one or more first project data using the identified one or more first software agents to identify one or more first intermediate data required for project factors estimation. The method further comprises calculating estimations of the project factors using the identified one or more first intermediate data.

This application claims the benefit of Indian Patent Application Serial No. 6990/CHE/2015 filed Dec. 28, 2015, which is hereby incorporated by reference in its entirety.

### TECHNICAL FIELD

The present subject matter is related, in general to software development, and more particularly, but not exclusively to a project estimation system and a method for predicting estimation of project factors in software development environment.

### BACKGROUND

At present, in software project management, planning and monitoring software project development is an essential task. Also, in software project development, accurate time management, cost management, and effort management is required. Therefore, it is very important to estimate cost, time and the amount of effort required and/or to be involved in the software project development. Such estimation helps in creating the software project as per available resources within the planned cost and the planned time including ability of users for creating the software project. However, presently, estimating the cost, time and the amount of efforts for developing a software project is a tedious job since it is manually performed by the users. Such manual estimation is prone to errors occurred while estimating the cost, the time and the amount of efforts for developing the software project.

In one conventional method, meta-heuristics techniques are used which could result an optimal solution in estimating the cost, time and the amount of efforts accurately. However, the conventional method limits estimating the cost, time and the amount of efforts only for small software projects. Further, the conventional method is not suitable for geographically diversified software projects and such conventional method is not feasible when there is lack of communication between the users involved in developing the software projects. Thus, in one conventional method, inaccurate estimates have resulted which can be very expensive for an organization and which affects the competitiveness of the organization.

In another conventional method, the cost, time and the amount of efforts are measured only for the software project using Software Development Life Cycles (SDLC) like Waterfall methodology, scrum methodology etc. As long as the SDLC is same throughout for the software project, there are no challenges in estimating efforts/duration and the cost. However, challenges occur when the SDLC of one of the software projects is changed from one SDLC type to another during the estimation for the development of software project. For example, a software project is started with time period of fourteen months with traditional Water Fall (WF) methodology. In such a case, the estimations are carried out only for the WF methodology. But, consider, after fifth month, because of change in technology, the same software project is converted from the WF methodology to agile mode of delivery. In such type of scenario, the challenge faced is how to calculate the estimate, when inputs for the WF methodology and inputs for the agile mode of delivery are different. Thus, computing an optimal solution by aggregating and correlating data for all the inputs of all the methodologies is a difficult task and is not carried out accurately according to this conventional method. Further, maintaining continuity of estimation of development of the software project by converting from one SDLC type to another without affecting already computed time and cost is a challenge in the conventional method.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

In one embodiment, the present disclosure relates to a method for predicting estimation of project factors in software development environment. The method comprises receiving first input data including at least one type of first software development model and associated one or more first project data from a user. The method further comprises identifying one or more first software agents based on the at least one type of the first software development model. The method further comprises processing the one or more first project data using the identified one or more first software agents to identify one or more first intermediate data required for project factors estimation. The method further comprises predicting estimations of the project factors using the identified one or more first intermediate data.

In another embodiment, the present disclosure relates to a project estimation system for predicting estimation of project factors in software development environment. The project estimation system comprises a processor and a memory communicatively coupled to the processor, wherein the memory stores processor-executable instructions, which, on execution, cause the processor to perform operations to receive first input data including at least one type of first software development model and associated one or more first project data from a user. The processor is configured to identify one or more first software agents based on the at least one type of the first software development model. The processor is further configured to process the one or more first project data using the identified one or more first software agents to identify one or more first intermediate data required for project factors estimation. The processor is further configured to predict estimations of the project factors using the identified one or more first intermediate data.

In another embodiment, the present disclosure relates to a non-transitory computer readable medium including instructions stored thereon that when processed by at least one processor causes a project estimation system for predicting estimation of project factors in software development environment. The project estimation system receives first input data including at least one type of first software development model and associated one or more first project data from a user. Thereafter the project estimation system identifies one or more first software agents based on the at least one type of the first software development model. The project estimation system processes the one or more first project data using the identified one or more first software agents to identify one or more first intermediate data required for project factors estimation. Thereafter the project estimation system predicts estimations of the project factors using the identified one or more first intermediate data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment having a project estimation system and other components in accordance with some embodiments of the present disclosure;

FIG. 2 illustrates a block diagram of the exemplary project estimation system with various data and modules for predicting estimations of project factors in software development environment in accordance with some embodiments of the present disclosure;

FIG. 3 shows a flowchart illustrating a method for predicting estimation of project factors in accordance with some embodiments of the present disclosure; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a project estimation system to predict estimation of project factors in software development environment. Embodiments of the present disclosure provide automated methodology for predicting estimation of the project factors such as cost, time and efforts required in developing a software project. Thus, in such a case, human intervention or error in predicting such estimations is eliminated. Also, due to automated methodology, the estimation of the project factors are predicted accurately based on user input data. The method comprises identifying first software agents corresponding to first input data which includes type of first software development model and first project data associated to the type of first software development model that have been received from a user. The first software agents include, without limitations, Main Agent (MA), Water Fall Agent (WFA), Agile Agent (AA), Effort Estimator Agent (EEA), Time Estimator Agent (TEA), Cost Estimator Agent (CEA) and other such agents referred for software development. The first software development model includes, without limitations, Waterfall (WF) model, agile XP (Extreme Programming) model, scrum model etc. The first project data related to the WF model may include, without limitations, number of Graphical User Interface (GUI) elements, external output units, external input units, internal logical files, data validation parameters, complexity factors, flow complexity parameters, data transfer units/parameters, code structure, inline data, comments, and object conjuration. Likewise, the first project data related to agile model may include, without limitations, number of stories, number of story units and complexity level of stories etc. The first project data is processed using corresponding identified first software agent to identify first intermediate data which is required for project factors estimation. The first intermediate data refers to features associated with the corresponding first software agent. For example, consider the agent is WF agent. By processing/analyzing the first project data corresponding to the WF agent, first intermediate data relating to the WF agent is identified. The intermediate data includes, but are not limited to, number of subsystems, classes/modules included in Lines of Source Code (LOC) of the WF agent, methods/functions included in the WF agent, number of screens utilized by the WF agent, dialogs, files, database tables, reports and messages utilized by the WF agent. Using the identified first intermediate data, estimation of the project factors such as the cost, time and the efforts are predicted. In an embodiment, the estimation of project factors corresponding to change of the first software development model to a second software development model are predicted. Consider the change in the first input data as a second input data having a type of the second software development model and associated second project data. Then, the agent corresponding to the second input data is different. For example, based on the second input data from the user, consider the WF model is changed to agile model. Accordingly, the second software agent corresponding to the second software development model and the associated second project data is identified. Upon identifying the second software agent, the first intermediate data is correlated with the second project data to obtain second intermediate data required for estimations as per changed software development model. To obtain the second project data, the second software agent acquires the first project data based on the second input data from the user. Then, the estimation of the project factors for the second software development model is predicted using the second project data and/or the second intermediate data.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

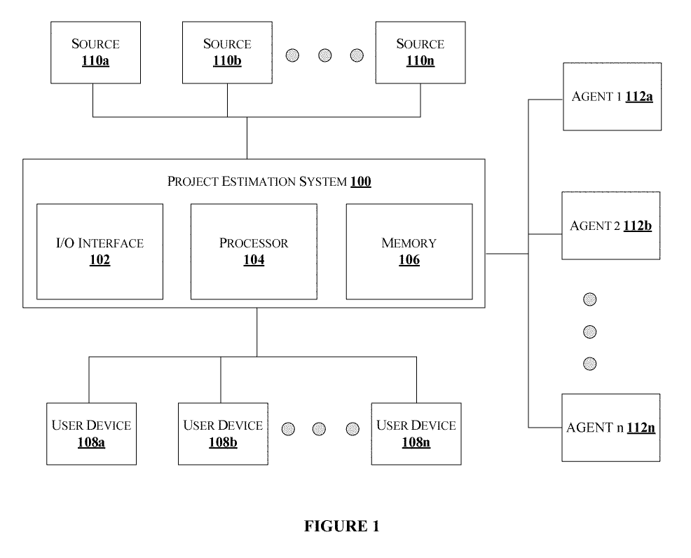

FIG. 1 illustrates an exemplary embodiment of environment for predicting estimations of project factors in software development environment in accordance with some embodiments of the present disclosure.

The environment comprises a project estimation system 100, one or more user devices 108a, 108b, . . . , 108n (collectively referred to 108), one or more sources 110a, 110b, . . . , 110n (collectively referred to 110) and one or more agents 112a, 112b, . . . , 112n (collectively referred to 112). In one implementation, the project estimation system 100 may be implemented in a variety of computing systems, such as a laptop computer, a desktop computer, a Personal Computer (PC), a notebook, a smartphone, a tablet, e-book readers (e.g., Kindles and Nooks), a node in a network, a server, a network server, and the like. In an embodiment, the project estimation system 100 is configured to predict estimations of the project factors in the software development environment. In an embodiment, the project estimation system 100 functions both in online and offline mode. The components of the project estimation system 100 are explained in detail in below sections of the description.

In an embodiment, the project estimation system 100 is communicatively connected to the one or more user devices 108, the one or more sources 110 and the one or more agents 112 over a network (not shown in FIG. 1).

The one or more user devices 108 are associated to the one or more users involved in a software project development. In an embodiment, the one or more users include, without limitations, a software developer, an analyst, a software programmer, etc. who are involved in the software project development. The one or more user devices 108 include, but are not limited to, computing systems, such as a laptop computer, a desktop computer, a Personal Computer (PC), a notebook, a smartphone, a smart watch, a wearable device, a tablet, e-book readers (e.g., Kindles and Nooks). In an embodiment, for the software project development in a software development environment, first input data including at least one type of first software development model and associated one or more first project data, and second input data including at least one type of second software development model and associated one or more second project data are provided to the project estimation system 100 using the one or more user devices 108. In an embodiment, the type of first and second software development model is related to Software Development Life Cycle (SDLC) involved in the software project development. For example, the type of first and second software development model may be a Water Fall (WF) model, agile XP model, scrum model etc. The one or more second project data is related to the second software development model which results due to change of the first software development model to the second software development model. The one or more first project data and the one or more second project data refer to parameters, units, systems, resources etc. associated with the type of corresponding first and second software development model respectively. The project data is provided based on type of estimation and software development model selected by the user. The type of estimation includes, without limitation, effort estimation, cost estimations, time estimations. In an embodiment, the one or more user devices 108 may act as the project estimation system 100. In such a case, the one or more user devices 108 can predict estimations of the project factors in the software development environment.

The one or more sources 110 refer to, without limitations, data stores or databases and storages which contain the input data, software development models, corresponding project data, history data, intermediate data, present data, cost estimation, time estimation, effort estimation etc. related to the corresponding software development model.

The one or more agents 112 refer to, without limitations, data stores or databases and storages which can store agents related to the corresponding software development model. For example, the agent repository may store one or more agents 112 which includes, but not limited to, Main Agent (MA), Agile Agent (AA), WF Agent (WFA), Effort Estimator Agent (EEA), Time Estimator Agent (TEA), Cost Estimator Agent (CEA) etc.

In the illustrated FIG. 1, the project estimation system 100 comprises an I/O interface 102, a central processing unit (“CPU” or “processor”) 104 having one or more processing units, and a memory 106 in accordance with some embodiments of the present disclosure.

The I/O interface 102 is a medium through which the first and the second software development models, corresponding first and second project data, history data, intermediate data, present data, cost estimation, time estimation, effort estimation etc. related to the corresponding first and second software development model is received. The I/O interface 102 is coupled with the processor 104. The processor 104 is configured to predict the estimation of the project factors in the software development environment.

The processor 104 may comprise at least one data processor for executing program components for processing system-generated software project for development. The processor 104 is configured to identify one or more first software agents based on the at least one type of the first software development model. The processor 104 processes/analyses the one or more first project data using the identified one or more first software agents to identify the one or more intermediate data required for project factors estimation. The processor 104 predicts the estimations of the project factors using the identified one or more first intermediate data. The processor 104 determines a change of the software development model from the first software development model to the second software development model from at least one type of second software development model and associated one or more second project data. The processor 104 identifies one or more second software agents based on the at least one type of second software development model. The processor 104 correlates the one or more first intermediate data and the one or more second project data to obtain one or more second intermediate data required for project factor estimation. The processor 104 predicts estimation of the project factors using the one or more second intermediate data and at least one of the one or more second project data. In an embodiment, the processor 104 acquires the one or more first project data for estimating the project factors of the second software development model. In an embodiment, the processor 104 generates a report of the predicted estimations of the project factors of the first software development model and/or the second software development model. Various functionalities performed by the processor 104 are achieved using one or more modules that are stored in the memory 106 which are explained in below description.

The memory 106 stores instructions which are executable by the at least one processor 104. In an embodiment, the memory 106 stores software development model data 202, project data 204, software agent's information 206, intermediate data 208, history data 210, estimations information 212, and report data 214. In an embodiment, the software development model data 202, the project data 204, the software agents information 206, the intermediate data 208, the history data 210, the estimations information 212, and the report data 214 are stored as one or more data 200 required for predicting estimations of the project factors in the software development environment as described in the following description of the disclosure.

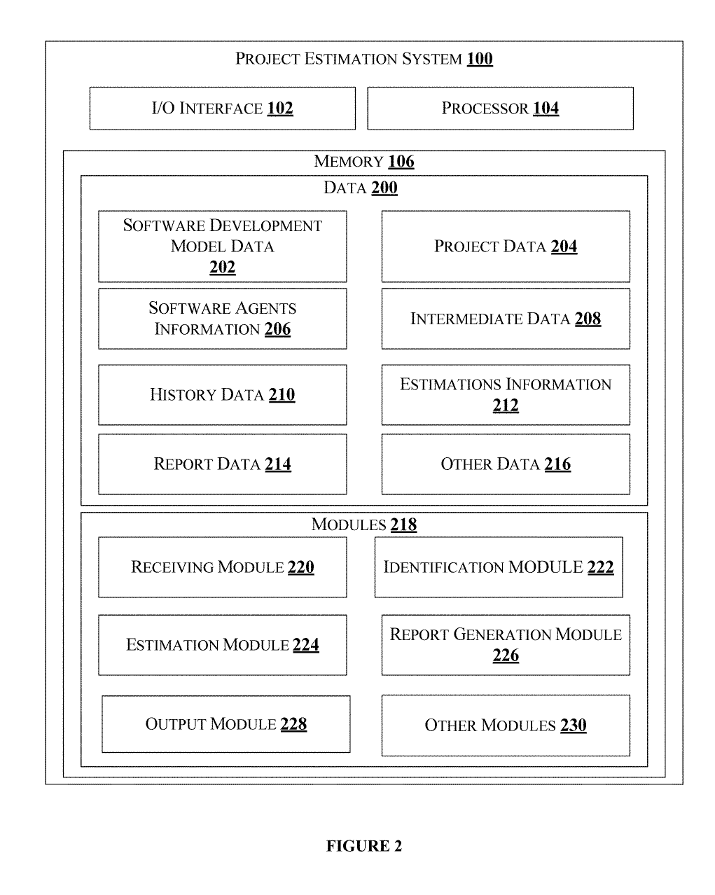

FIG. 2 illustrates a block diagram of the exemplary project estimation system 100 with various data and modules for predicting estimation of the project factors in the software development environment in accordance with some embodiments of the present disclosure. In the illustrated FIG. 2, the one or more data 200 and the one or more modules 218 stored in the memory 206 are described herein in detail.

In an embodiment, the one or more data 200 may include, for example, the software development model data 202, the project data 204, the software agents information 206, the intermediate data 208, the history data 210, the estimations information 212, and the report data 214 and other data 216 for predicting the estimations of the project factors in the software development environment.

The software development model data 202 refers to data of software development models in the SDLC for developing the software project. The software development model includes, without limitations, Waterfall (WF) model, agile model, scrum model etc.

The project data 204 is associated with the type of corresponding software development model respectively. The user may be required to provide project data 204 based on the software development model and type of estimation being selected. For example, consider the user selecting the WF model and type of estimation as effort estimation to be calculated. Then, the user need to provide the project data 204 related to the WF model as including, without limitations, number of Graphical User Interface (GUI) elements, external output units, external input units, internal logical files, data validation parameters, complexity factors, flow complexity parameters, data transfer units/parameters, code structure, inline data, comments, and object conjuration. Likewise, the project data 204 related to agile model may include, without limitations, number of stories, number of story units and complexity level of stories etc. If the user selects cost estimation, the user need to provide project data 204 that includes, without limitations, size of software, software quality requirements, hardware requirements, additional tolls, licenses, skill personnel with task specific skills, travel cost, communication cost, training and support cost etc. In an embodiment, the software development model and the corresponding project data 204 are stored as input data.

The software agent's information 206 refers to software agents stored in the one or more agent repositories that are used for the software project development. The software agents include, without limitations, Main Agent (MA), Agile Agent (AA), WF Agent (WFA), Effort Estimator Agent (EEA), Time Estimator Agent (TEA), Cost Estimator Agent (CEA) etc.

The intermediate data 208 refers to features associated with the corresponding software agent. For example, consider the agent is WF agent. The intermediate data 208 relating to the WF agent includes number of subsystems, classes/modules included in Lines of Source Code (LOC) of the WF agent, methods/functions included in the WF agent, number of screens utilized by the WF agent, dialogs, files, database tables, reports and messages utilized by the WF agent etc. The intermediate data 208 includes present data/current data of the corresponding software agent.

The history data 210 refers to features associated with the corresponding software agent resulted in the past/previous software development process/cycle.

The estimations information 212 refers to estimation of the project factors being predicted for the software project development corresponding to the software development model. The estimations information 212 includes, without limitation, cost estimation being predicted, time estimation being predicted, and effort estimation being predicted.

The report data 214 refers to reports being generated for estimations of the project factors being predicted.

The other data 216 may refer to such data which can be referred for predicting the estimation of the project factors in the software development environment.

In an embodiment, the one or more data 200 in the memory 106 are processed by the one or more modules 218 of the project estimation system 100. The one or more modules 218 may be stored within the memory 106 as shown in FIG. 2. In an example, the one or more modules 218, communicatively coupled to the processor 104, may also be present outside the memory 106 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 218 may include, for example, a receiving module 220, an identification module 222, an estimation module 224, a report generation module 226, and an output module 228. The memory 106 may also comprise other modules 230 to perform various miscellaneous functionalities of the project estimation system 100. It will be appreciated that such aforementioned modules may be represented as a single module or a combination of different modules.

The receiving module 220 receives the first input data including the type of first software development model and associated one or more first project data from the one or more user devices 108. In an embodiment, the first input data is stored in the data store and/or the project data 204 as soon as the first input data is received from the user.

The identification module 222 identifies the one or more first software agents based on the type of first software development model and/or the project data provided by the user. For example, consider the user selects the agile model and wishes to estimate effort required for software development. In such a case, the user provides the first input data, WF model/agile model, type of estimation, number of GUI elements, the data validation parameters, the complexity factors, the story points, the flow complexity, the data transfer factors, the code structure parameters, the inline data units, comments, object conjuration. Likewise, considering, the user wishes to estimate cost, then the user provides the project data such as size of software, the software quality requirements, the hardware requirements, the additional tools, the licenses, the skill personnel with task-specific skills, the travel cost, the communication cost, the training and the support cost etc. Based on the project data provided by the user, the corresponding software agent associated with the project data is identified. For example, if the received project data is associated to the agile model, the Agile Agent (AA) is identified. Likewise, if the received project data is associated to the WF model, then the WFA is identified.

The estimation module 224 processes or analyzes the one or more first project data to identify one or more first intermediate data required for project factors estimation. In particular, the corresponding first software agent processes or analyzes the one or more first project data to identify the one or more first intermediate data required for project factors estimation. For example, the WFA processes or analyzes the one or more first project data such as type of estimation, number of GUI elements, the data validation parameters, the complexity factors, the story points, the flow complexity, the data transfer factors, the code structure parameters, the inline data units, comments, object conjuration. Then, from the analysis, the WFA identifies the first intermediate data such as number of subsystems, classes/modules included in Lines of Source Code (LOC) of the WF agent, methods/functions included in the WF agent, number of screens utilized by the WF agent, dialogs, files, database tables, reports and messages utilized by the WF agent etc.

In an embodiment, the estimation module 224 predicts the estimations of the project factors such as cost, time and effort using the identified one or more first intermediate data. The estimation module 224 coordinates with the corresponding first software agent to predict the estimation. For example, the WFA agent predicts the cost estimation using below equation (1):

Te=(To+4Tm+Tp)/6 (1)

Where Te is time required for total Effort, Tm is the most likely time required, To is the most optimistic time required and Tp is the most pessimistic time required. In an embodiment, the Agile Agent (AA) uses the story points units for calculations which depend on the number of stories present in the agile model and associated agile project data. The AA predicts the cost estimation as follows. Considering, total points in product backlog is 300 points, burndown rate per sprint is 20 points, number of sprints of 2 weeks is 300 divided by 20 which results in 15 sprints. Now, number of weeks for 15 sprints required is 30 weeks (15*2). Now, assuming additional weeks for production release is 4 weeks. The total estimated weeks for the project is 34 weeks, employee cost per week involved is $5000. Now considering, there are 4 people working in agile project. Therefore, total cost for 4 people is 5000*34*4 which results in $680000 (34 Weeks*4 People*$5000).

In an embodiment, the cost estimation is the iterative process of developing an approximation of the monetary resources required to complete project activities. The cost of the software project can either be variable or fixed. The cost estimation includes costs for all resources such as labor, materials, equipment, services, software, hardware, facilities, contingency, etc. Consider the identified first software agent is CEA. The CEA accumulates cost inputs from the user for the above resources. In an embodiment, the CEA uses Program Evaluation and Review Techniques (PERT) method for predicting the estimation. The CEA predicts the cost estimation using the below equation (2):

Cost Estimate (Ce)=(Co+4Cm+Cp)/6 (2)

Where, Co is optimistic cost, Cm is most likely cost, Cp is pessimistic cost.

In an embodiment, the time estimation by the WFA is predicted using three point estimates which is given in below equation (3):

Expected Activity Duration (EAD)=P+4M+O/6 (3)

Where P is Pessimistic, M is Most Likely, O is Optimistic, activity Standard Deviation (SD) is P−O/6 and Activity Variance (AV)=(P−O/6)̂2.

For example, consider P is 48; M is 44 and 0 is 39. The EAD calculates is:

$$\begin{matrix}EAD = 48 + 4 ( 44 ) + 39 \text{/} 6 \\ = 48 + 176 + 39 \text{/} 6 = 43.83\end{matrix}$$

$$SD = 48 - 39 \text{/} 6 = 1.5 \\ AV = ( 1.5 ) \hat{} 2 = 2.25$$

Based on above calculation, the final time estimate for the given WF project data is as given below in equation (4):

Time estimation=EAD+SD or EAD−SD (4)

Time Range=43.83+/−1.5 Hours=45.83 Hours=5.7 Man Days.

Now, considering, cost per hour is $70/− and number of people are 2. Therefore, the total cost for the above time=45.83*$70*2=$6416.20/−.

In an embodiment, the estimation module 224 acquires the first intermediate data of the first software agent to predict the estimations for a change in the software development model and change in the corresponding first project data. More particularly, the user may change the software development model from the first software development model to the second software development model by providing second input data next to the first input data. That is, the second input data indicates change of the first software development model to the second software development model. In such a case, the second project data is provided which is corresponding to the second software development model. Then, the identification module 222 identifies the one or more second software agents based on the type of second software development model. Then, the estimation module 224 correlates the one or more first intermediate data and the one or more second project data associated with the second software development model to obtain one or more second intermediate data required for project factor estimation. For example, consider the user changes the software project from WF to agile model. Now, the AA is identified based on the new software project model. The AA correlates and compares the previous/history data, and the present data. For example, initially, WF model and its project data are analyzed for calculating the size of the project which is measured from the LOC and product features. The WFA uses the approach such as Function Points (FP) to convert the LOC count into an estimate of size. In an embodiment, the product features may include number of subsystems, classes/modules, methods/functions, number of screens, dialogs, files, database tables, reports and messages. Now, after the 5 months, the WF project is changed to agile project. The intermediate data and/or the history data of the WF project calculated by the WFA is used by the AA to calculate the estimations for agile project. For example, the AA collects the project size, the number of resources, the estimated time and the total cost spent for the last 5 months. Also, considering, the WF agent had used data like Project Size, time, and number of resources, after the change of the project into agile, the AA acquires data like time and number of resources from the WF Agent required for the agile project factors estimation. This is accomplished because of agent's inter communication capabilities.

For example, if a project is estimated for 12 months, wherein the first 3 months are in Waterfall and last 9 months was in Agile. Then, for the first 3 months, the time estimation is calculated as below:

Time duration,(505+4*510+515)/6=3060/6=510 hrs. (6)

Where, optimistic time is To=3*21=63 Days; 63*8=505 hrs (8 Hours per day), Most likely is Tm=510 hrs, and Pessimistic time is Tp=515 hrs. Therefore, the estimated duration for the said activity for 3 months=510 hrs. For the remaining 9 months, the time estimation predicted is as below:

Time duration=12−3=9 months; 9*21=189 Days; 189*8=1512 Hours (7)

In an embodiment, the AA calculates the remaining hours. In such a case, the agile project estimation has to be done for remaining 1512 hours. Therefore, 75% of work is utilized for sprint development in Agile model and 25% of work is utilized for other additional work by AA. In that case, 75% of 1512 is 1134 hours. If there are three people in the project, then 1134*3=3402 (units) worth of work is calculated to be completed in 9 months of time.

Considering another example, wherein after 7 sprint in Agile model, the user is changing the delivery from agile to WF model. The WFA calculates the estimations for the remaining weeks.

Remaining Time (in Weeks)=8 Sprints=16+4 (4 additional)=20 Weeks. Therefore, cost for 4 people=20 Weeks*5000*4=$400000

The estimation module 224 predicts the estimation of the project factors using the one or more second intermediate data and at least one of the one or more second project data associated to the second software development model as explained above.

In an embodiment, the report generation module 226 generates the report corresponding to each estimation being predicted.

The output module 228 provides the report being generated to the one or more user devices 108 and/or a display unit of the project estimation system 100.

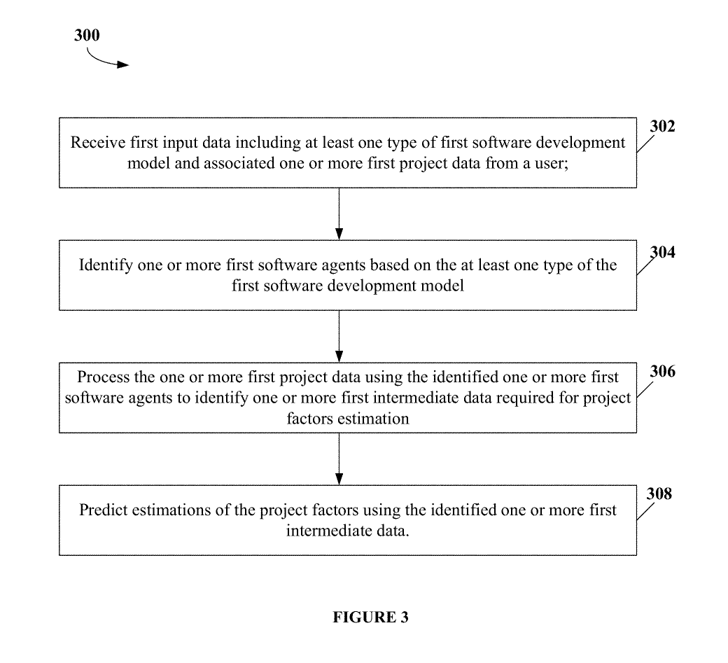

FIG. 3 shows a flowchart illustrating a method 300 for predicting the estimations of the project factors in the software development environment in accordance with some embodiments of the present disclosure.

As illustrated in FIG. 3, the method comprises one or more blocks for predicting the estimations of the project factors in the software development environment. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method 300 can be implemented in any suitable hardware, software, firmware, or combination thereof.

At block 302, the first input data including the type of first software development model and the associated one or more first project data are received from the user.

At block 304, the one or more first software agents are identified based on the type of the first software development model.

At block 306, the one or more first project data are processed using the identified one or more first software agents to identify one or more first intermediate data required for project factors estimation.

At block 308, the estimations of the project factors are predicted using the identified one or more first intermediate data. In an embodiment, the project factors comprise the cost estimation, time estimation and the effort estimation required in the software development environment. In an embodiment, the second input data including type of second software development model and the associated one or more second project data are received from the user. The second input data indicates change of the first software development model to a second software development model. The one or more second software agents are identified based on the type of second software development model. The one or more first intermediate data and the one or more second project data associated with the second software development model are correlated with each other to obtain one or more second intermediate data required for project factor estimation. The estimation of the project factors are predicted using the one or more second intermediate data and at least one of the one or more second project data associated to the second software development model. In an embodiment, the first input data, the second input data, the one or more first project data associated to the first software development models and the one or more second project data associated to the second software development models, the one or more first intermediate data, and the one or more second intermediate data are stored in the data store associated to the project estimation system 100. In an embodiment, the one or more first project data are acquired as per the second input data from the user for estimating the project factors of the second software development model. In an embodiment, the reports of the predicted estimations of the project factors of the first software development model and/or the second software development model is generated.

### Computer System

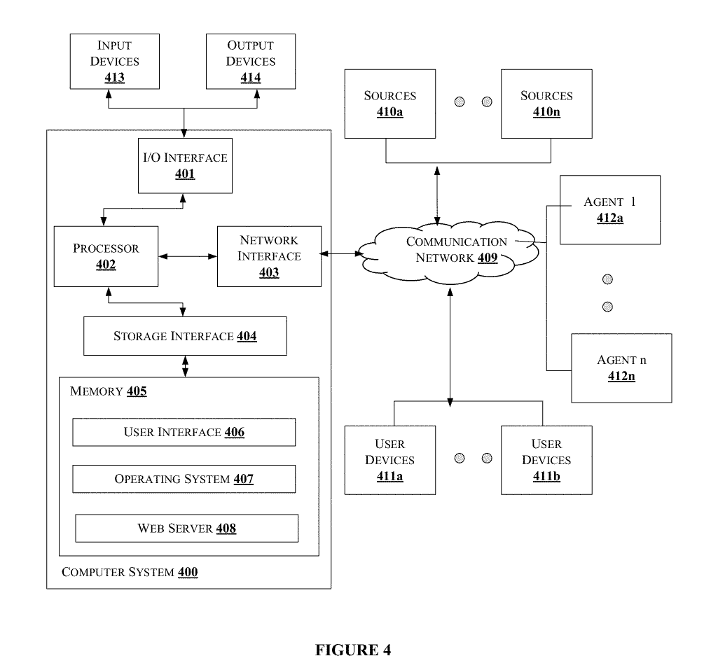

FIG. 4 illustrates a block diagram of an exemplary computer system 400 for implementing embodiments consistent with the present disclosure. In an embodiment, the computer system 400 is used to implement the project estimation system 100. The computer system 400 may comprise a central processing unit (“CPU” or “processor”) 402. The processor 402 may comprise at least one data processor for executing program components for executing system-generated test suite and test cases for testing the software programs. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 400 is connected to the one or more user devices 411a, . . . , 411n, and the one or more sources 410a, . . . , 410n through a communication network 409. The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with the one or more user devices 411a, . . . , 411n, and the one or more servers 410a, . . . , 410n. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 404, web server 408 etc. In some embodiments, computer system 400 may store user/application data 406, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 400 may implement a web browser 407 stored program component. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure provide a method and system for estimating project factors in project development environment.

The present disclosure use intelligent agent based techniques for the estimation because of which the user will be able to get more detailed information on the project factors with minimal input.

Further, in the present invention the agents communicate with each other based on the requirements so that it maximizes the code reusability in the estimation process.

The present invention may be used for multiple types of project effort estimations and also user friendly for finding size of the software and in estimating the effort required in software development environment.

The present invention provides cloud based solution which may serve multiple project stakeholders irrespective of their locations and size of projects.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Project estimation system |
| 102 | I/O Interface |
| 104 | Processor |
| 106 | Memory |
| 108a, . . . , 108n | User Devices |
| 110, . . . , 110n | Sources |
| 112, . . . , 112n | Agents |
| 200 | Data |
| 202 | Software development model data |
| 204 | Project data |
| 206 | Software agents information |
| 208 | Intermediate data |
| 210 | History data |
| 212 | Estimations information |
| 214 | Report data |
| 216 | Other Data |
| 218 | Modules |
| 220 | Receiving Module |
| 222 | Identification Module |
| 224 | Estimation Module |
| 226 | Report Generation Module |
| 228 | Output Module |
| 230 | Other Modules |
| 400 | Computer System |
| 401 | I/O Interface |
| 402 | Processor |
| 403 | Network Interface |
| 404 | Storage Interface |
| 405 | Memory |
| 406 | User Interface |
| 407 | Operating System |
| 408 | Web Server |
| 409 | Communication Network |
| 410a, . . . , 410n | Sources |
| 411a, . . . , 411n | User Devices |
| 412a, . . . ., 412n | Agents |
| 413 | Input Devices |
| 414 | Output Devices |

What is claimed is:

1. A method for predicting estimation of project factors in software development environment, the method comprising:
receiving, by a project estimation device, first input data including at least one type of first software development model and associated one or more first project data from a user;
identifying, by the project estimation device, one or more first software agents based on the at least one type of the first software development model;
processing, by the project estimation device, the one or more first project data using the identified one or more first software agents to identify one or more first intermediate data required for project factors estimation; and
predicting, by the project estimation device, estimations of the project factors using the identified one or more first intermediate data.

2. The method as claimed in claim 1 comprising:
receiving, by the project estimation device, second input data including at least one type of second software development model and associated one or more second project data from the user, wherein the second input data indicates change of the first software development model to a second software development model;
identifying, by the project estimation device, one or more second software agents based on the at least one type of second software development model;
correlating, by the project estimation device, the one or more first intermediate data and the one or more second project data associated with the second software development model to obtain one or more second intermediate data required for project factor estimation; and
predicting, by the project estimation device, estimation of the project factors using the one or more second intermediate data and at least one of the one or more second project data associated to the second software development model.

3. The method as claimed in claim 2, wherein the first input data, the second input data, the one or more first project data associated to the first software development models and the one or more second project data associated to the second software development models, the one or more first intermediate data, and the one or more second intermediate data are stored in a data store associated to the project estimation system.

4. The method as claimed in claim 1, wherein the project factors comprise at least one of cost estimation, time estimation and effort estimation required in the software development environment.

5. The method as claimed in claim 1 further comprising generating by the project estimation device, a report of the predicted estimations of at least one of the project factors of at least one of the first software development model and the second software development model.

6. The method as claimed in claim 2 further comprising acquiring by the project estimation device, the one or more first project data as per the second input data from the user for estimating the project factors of the second software development model.

7. A project estimation device comprising:
a processor;
a memory communicatively coupled to the processor, wherein the memory stores processor-executable instructions, which, on execution, cause the processor to:
receive first input data including at least one type of first software development model and associated one or more first project data from a user;
identify one or more first software agents based on the at least one type of the first software development model;
process the one or more first project data using the identified one or more first software agents to identify one or more first intermediate data required for project factors estimation; and
predict estimations of the project factors using the identified one or more first intermediate data.

8. The project estimation device as claimed in claim 7, wherein the processor further configured to:
receive second input data including at least one type of second software development model and associated one or more second project data from the user, wherein the second input data indicates change of the first software development model to a second software development model;
identify one or more second software agents based on the at least one type of second software development model;
correlate the one or more first intermediate data and the one or more second project data associated with the second software development model to obtain one or more second intermediate data required for project factor estimation; and
predict estimation of the project factors using the one or more second intermediate data and at least one of the one or more second project data associated to the second software development model.

9. The project estimation device as claimed in claim 8, wherein the first input data, the second input data, the one or more first project data associated to the first software development models and the one or more second project data associated to the second software development models, the one or more first intermediate data, and the one or more second intermediate data are stored in a data store associated to the project estimation system.

10. The project estimation device as claimed in claim 8, wherein the project factors comprise at least one of cost estimation, time estimation and effort estimation required in the software development environment.

11. The project estimation device as claimed in claim 8, wherein the processor is further configured to generate a report of the predicted estimations of at least one of the project factors of at least one of the first software development model and the second software development model.

12. The project estimation device as claimed in claim 9, wherein the processor is further configured to acquire the one or more first project data as per the second input data from the user for estimating the project factors of the second software development model.

13. A non-transitory computer readable medium including instructions stored thereon that when processed by a processor cause a project estimation device for predicting estimations of project factors in software development environment to perform acts of:
receiving first input data including at least one type of first software development model and associated one or more first project data from a user;
identifying one or more first software agents based on the at least one type of the first software development model;
processing the one or more first project data using the identified one or more first software agents to identify one or more first intermediate data required for project factors estimation; and
predicting estimations of the project factors using the identified one or more first intermediate data.

14. The medium as claimed in claim 13, wherein the instruction cause the processor to perform operations comprising:
receiving, by the project estimation system, second input data including at least one type of second software development model and associated one or more second project data from the user, wherein the second input data indicates change of the first software development model to a second software development model;
identifying, by the project estimation system, one or more second software agents based on the at least one type of second software development model;
correlating, by the project estimation system, the one or more first intermediate data and the one or more second project data associated with the second software development model to obtain one or more second intermediate data required for project factor estimation; and
predicting, by the project estimation system, estimation of the project factors using the one or more second intermediate data and at least one of the one or more second project data associated to the second software development model.

15. The medium as claimed in claim 14, wherein the first input data, the second input data, the one or more first project data associated to the first software development models and the one or more second project data associated to the second software development models, the one or more first intermediate data, and the one or more second intermediate data are stored in a data store associated to the project estimation system.

16. The medium as claimed in claim 13, wherein the project factors comprise at least one of cost estimation, time estimation and effort estimation required in the software development environment.

17. The medium as claimed in claim 13, wherein the instructions further cause the processor to generate a report of the predicted estimations of at least one of the project factors of at least one of the first software development model and the second software development model.

18. The medium as claimed in claim 14, wherein the instruction further cause the processor to acquire the one or more first project data as per the second input data from the user for estimating the project factors of the second software development model.
